(19) United States
(12) Patent Application Publication
(10) Pub. No.: US 2013/0126645 A1
(43) Pub. Date: May 23, 2013

(54) MULTI-FUNCTION OUTLET MECHANISM

(71) Applicants: Huasong Zhou, Xiamen (CN); Yonghua Chen, Xiamen (CN); Haisong Peng, Xiamen (CN); Jianmin Chen, Xiamen (CN)

(72) Inventors: Huasong Zhou, Xiamen (CN); Yonghua Chen, Xiamen (CN); Haisong Peng, Xiamen (CN); Jianmin Chen, Xiamen (CN)

(73) Assignees: XIAMEN SOLEX HIGH-TECH INDUSTRIES CO., LTD., Xiamen, Fujian (CN); Huasong ZHOU, Xiamen, Fujian (CN)

(21) Appl. No.: 13/813,353

(22) PCT Filed: Aug. 12, 2011
(86) PCT No.: PCT/CN2011/078328

§ 371 Date: Jan. 30, 2013

(30) Foreign Application Priority Data
Aug. 17, 2010 (CN) 201010255591.9
Aug. 17, 2010 (CN) 201020294428.9

(51) Int. Cl. B05B 1/18

(52) U.S. Cl. CPC B05B 1/18
USPC 239/581.1

(57) ABSTRACT

The present invention discloses a multi-function outlet mechanism, it comprises a fixed unit, a rotary assembly and two outlet terminals, the fixed unit is provided with an inlet end; the rotary assembly comprises a handle and a control part, the handle is mounted to the fixed unit in a rotating manner, and the control part is arranged in the fixed unit; the outlet terminals are arranged on the fixed unit respectively, and water comes out of the outlet terminals simultaneously or separately along with the relative rotation between the rotary assembly and the fixed unit, the outlet effect of one of the outlet terminals is waterfall water. The present multi-function outlet mechanism integrates multiple outlet terminals into one body, the structure is compact, and the function is various, and the applicability is strong.

### FIELD OF THE INVENTION

The present invention relates to a multi-function outlet mechanism, more particular to an outlet mechanism used in shower equipment.

### BACKGROUND OF THE INVENTION

The multi-function outlet mechanism used in shower equipment at the prior, such as the shower auto switch device (utility model, Chinese application number CN200520080271.9) and the vertical rotary switch device (utility model, Chinese application number CN200820146238.5), all disclose a outlet mechanism for switching different outlet terminals, wherein different outlets are arranged to respectively communicated with different outlet terminals (such as head shower, the handheld shower and etc.), although the said outlet mechanisms are able to switch waterways, the structure is complicated, and a switch unit is needed to be arranged in the body, and a operating unit is also arranged out of the body to achieve switch, which make the switch process verbose; in addition, the body of the said outlet mechanism is not able to connected the outlet terminals directly, namely the body is provided with no outlet functions, and a connector (such as a tube) is needed to be arranged to connect different outlet terminal, so the whole structure is complicated, and the product is not lightly and handy enough, and the manufacture procedure is also complicated.

### SUMMARY OF THE INVENTION

The object of the present invention is to offer a Multi-function outlet mechanism which overcomes the defect of the outlet mechanism at the prior.

The technical proposal solving the technical matter in the present invention is:

Multi-function outlet mechanism, comprises a fixed unit, a rotary assembly and two outlet terminals,

the fixed unit is provided with an inlet end;

the rotary assembly comprises a handle and a control part, the handle is mounted to the fixed unit in a rotating manner, and the control part is arranged in the fixed unit;

the outlet terminals are arranged on the fixed unit respectively, and water comes out of the outlet terminals simultaneously or separately along with the relative rotation between the rotary assembly and the fixed unit, the outlet effect of one of the outlet terminals is waterfall water.

In a preferred embodiment, the fixed unit also comprises a water division disc, and an inlet cavity communicating with the inlet end is formed by the water division disc and the fixed unit.

In a preferred embodiment, the inlet cavity is provided with an inlet hole, two water division holes communicating the inlet hole with the outlet terminals respectively are opened on the water division disc.

In a preferred embodiment, the control part is a sealing gasket which is adaptive to the two water division holes and linked with the handle.

In a preferred embodiment, also comprises a locating unit which comprises a locating pin and a locating spring that is against the locating pin, and three locating holes adaptive to the locating pin are arranged on the water division disc.

In a preferred embodiment, a locating slot adaptive to the locating unit is arranged on the end face of the handle.

In a preferred embodiment, the two outlet terminals are respectively arranged at different position of the outer surface of the fixed unit.

In a preferred embodiment, a limit gap is arranged at the fixed unit, a limit boss adaptive to the limit gap is arranged at the corresponding position of the handle.

In a preferred embodiment, a waterfall water outlet cavity is opened in the fixed unit, a waterfall water cover body covers the waterfall water outlet cavity, and a plurality of turbulent blocks are arranged in the waterfall water cover body, and the waterfall water cover body is involute structure, and its outlet expands outward with two big sides and small middle, and the water passing areas are equal to each other along the outlet direction.

In a preferred embodiment, also comprises a socket fixedly connected to the fixed unit.

In a preferred embodiment, the sealing gasket is sector structure, and is mounted at the lower end of the handle, and rotates along with the handle to block or communicate with the water division hole.

In a preferred embodiment, the water division hole is cashew-shaped, the arc length of the sector structure of the sealing gasket is longer than the long apertures of the first water division hole and the second water division hole, and the width of the sector structure of the sealing gasket is not less than the short apertures of the first water division hole and the second water division hole.

In a preferred embodiment, a splicing part is arranged at the lower end of the handle, and the sealing gasket is mounted at the splicing part at the lower end of the handle.

Compared with the technical proposal at the prior, the benefits of the present invention are: 1 the outlet mechanism is provided with two outlet terminals, one of the outlet terminals is provided with waterfall water effect, and the two outlet terminals are directly arranged on the fixed unit and rotate with respect to the fixed unit through the rotary assembly, namely water comes the outlet terminals simultaneously or respectively, a plurality of outlet terminals are integrated into one body with compact structure and complete function; 2 because a water division disc is also arranged at the fixed unit, and a inlet cavity is formed between the water division disc and the fixed unit, water division and switch are achieved under the cooperation of the fixed unit and the rotary assembly; 3 because the inlet cavity of the water division disc is provided with a inlet hole and two water division holes, the inlet cavity is alternatively communicated with the two water division holes along with the rotation of the handle, and waterway switch is achieved; 4 the control part of the rotary assembly is a sealing gasket, so it can seal or communicate with the two water division holes along with the rotation of the handle; 5 the locating unit locates the rotation of the rotary assembly, so the switch stability is enhanced; 6 because of the locating slot arranged on the handle, the locating unit can be contained in the locating slot and cooperate with the water division disc; 7 because the outlet terminals are located at different positions of the outer surface of the fixed unit, they will not interfere with each other with effective space utilization; 8 because the limit gap of the fixed unit is coupling with the limit boss of the handle, the rotation range of the handle is limited, namely the rotation range of the sealing gasket on the water division disc is limited; 9 an outlet cavity for waterfall water is opened in the fixed unit, coupling with the waterfall water cover body, and a plurality of turbulent blocks are arranged in the cover body to make the water pressure evenly distributed, and the cover body is involute structure, and the outlet of the cover body expands outward with two big sides and small middle, so the contracting and crossing of water is avoided, and the water passing areas are equal to each other along the outlet direction, so water comes out more even; 10 a socket is also arranged to the outlet mechanism, it can be used for clamping the outlet terminals (such as shower), and also can be used for placing stuff, so the applicability is enhanced.

### BRIEF DESCRIPTION OF THE DRAWINGS

FIG. 1 shows the solid abridged general view of the multi-function outlet mechanism in the embodiment 1;

FIG. 2 shows the solid exploded view of the multi-function outlet mechanism in the embodiment 1;

FIG. 3 shows the internal structure view of the first outlet cover body (waterfall water cover body) in the embodiment 1;

FIG. 4 shows the solid abridged general view of the handle in the embodiment 1;

FIG. 5 shows the coupling view of the sealing gasket and the water division disc in the embodiment 1, water comes out of the first outlet terminal;

FIG. 6 shows the sectional view of multi-function outlet mechanism in the embodiment 1, water comes out of the first outlet terminal;

FIG. 7 shows the coupling view of the sealing gasket and the water division disc in the embodiment 1, water comes out of the first and the second outlet terminal;

FIG. 8 shows the sectional view of multi-function outlet mechanism in the embodiment 1, water comes out of the first and the second outlet terminal;

FIG. 9 shows the coupling view of the sealing gasket and the water division disc in the embodiment 1, water comes out of the second outlet terminal;

FIG. 10 shows the sectional view of multi-function outlet mechanism in the embodiment 1, water comes out of the second outlet terminal

### REFERENCE SIGN

Fixed unit—100; inlet end—110; water division disc—120; inlet hole—121; first and second water division holes—122 and 123; first, second and third locating holes—124, 125, 126; inlet cavity—130; limit gap—140; shaft hole—150; rotary assembly—200; handle—210; locating slot—211; limit boss—212; rotary shaft—213; fillet—214; sealing gasket—220; first outlet terminal—300; first outlet cavity—310; first outlet cover body—320; turbulent block—321; outlet—322; second outlet terminal—400; locating unit—500; locating pin—510; locating spring—520; socket—600.

### DESCRIPTION OF THE PREFERRED EMBODIMENTS

With the following description of the drawings and specific embodiments, the invention shall be further described in details.

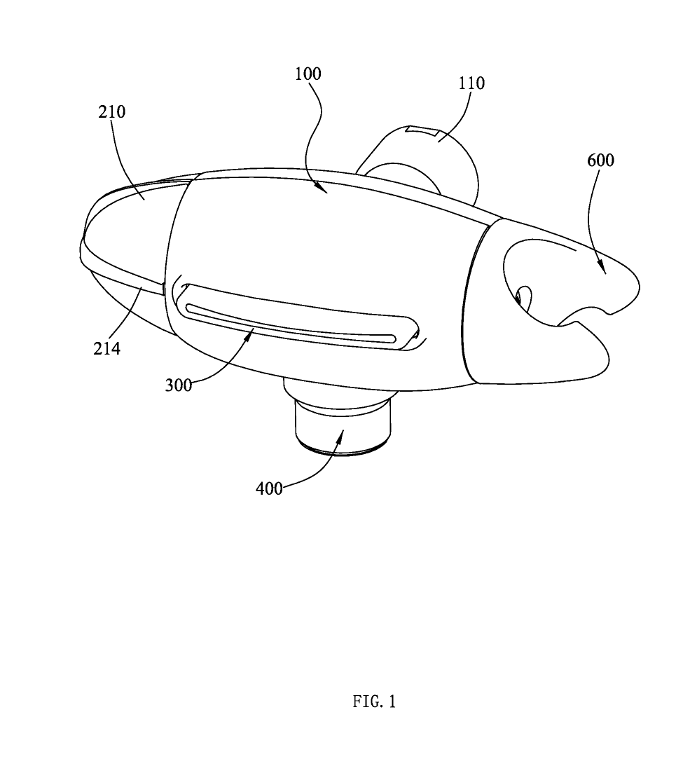

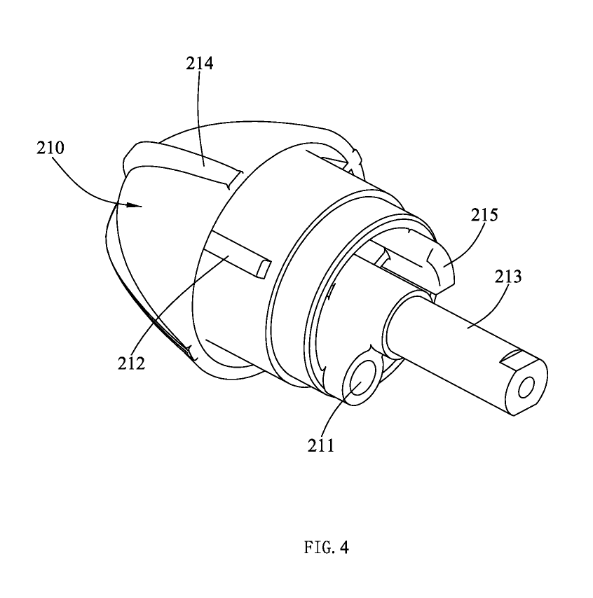

According to FIG. 1 to FIG. 10, the outlet mechanism in the present invention is present, it comprises a fixed unit 100, a rotary assembly 200, a first outlet terminal 300, a second outlet terminal 400, a locating unit 500 and a socket 600.

According to FIGS. 1, 2, 5, 7 and 9, an inlet end 110 communicating with water resource is arranged at the fixed unit 100, and a water division disc 120 is fixedly arranged in the fixed unit 100, an inlet cavity 130 communicating with the inlet end 110 is formed between the water division disc 120 and the fixed unit 100, and the inlet cavity 130 is provided with an inlet hole 121 opened on the end face of the water division disc 120, and two independent water division holes 122 and 123 and three locating holes 124, 125 and 126 are also opened on the end face of the water division disc 120, and a shaft hole 150 is located in the centre of the water division disc 120, and a limit gap 140 is arranged on the outer surrounding surface of one end of the fixed unit 100.

According to FIGS. 1, 2 and 4, the rotary assembly 200 comprises a handle 210 and a control part, the handle 210 is inserted into the shaft hole 150 through the rotary shaft 213 and is mounted at one end of the fixed unit 100 in a rotating manner, a part of which is exposed out of the fixed unit 100 for user's rotating, and a plurality of fillets 214 can be designed on the outer surface of the exposed part of the handle 210 to increase friction with improved user's rotating handfeel. The handle 210 is provided with a limit boss 212 which is cooperating with the limit gap 140 of the fixed unit 100 to limit the rotation range of the handle 210 with respect to the fixed unit 100, and a locating slot 211 is arranged on the inner end face of the handle 210.

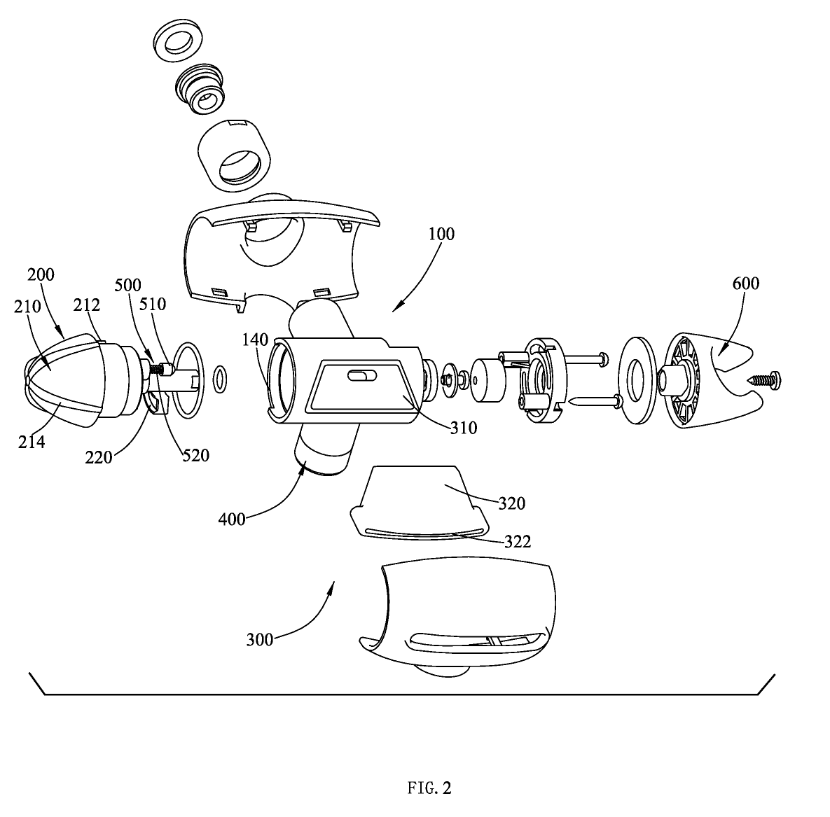

According to FIGS. 2, 5, 7 and 9, the control part is a sealing gasket 220 which is sector structure and is mounted at the lower end of the handle 210, rotating along with the handle 210 and in the end face of the water division disc 120 with limited turning range which is adaptive to the rotation range of the handle 210 with respect to the fixed unit 100, and the arc length of the sealing gasket 220 is longer than the apertures of the first water division hole 122 and the second water division hole 123, and in the present embodiment, the arc length of the sealing gasket 220 is also shorter than the gap between the first water division hole 122 and the second water division hole 123, and the arc length of the sealing gasket 220 is of course slightly longer than the gap between the first water division hole 122 and the second water division hole 123, therefore it is ensured that the first water division hole 122 and the second water division hole 123 are surely not completely blocked by the sealing gasket 220 when the sealing gasket 220 is not aligned with the first water division hole 122 and the second water division hole 123. The first water division hole 122 and the second water division hole 123 are cashew-shaped, and the arc length of the sector structure of the sealing gasket 220 is longer than the long apertures of the first water division hole 122 and the second water division hole 123, and the width of the sector structure of the sealing gasket 220 is not less than the short apertures of the first water division hole 122 and the second water division hole 123; a splicing part 215 is arranged at the lower end of the handle 210, and the sealing gasket 220 is mounted at the splicing part 215 at the lower end of the handle 210.

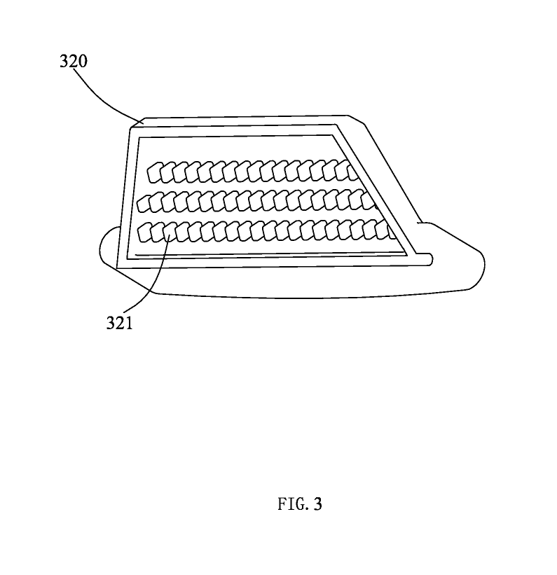

The first outlet terminal 300 and the second outlet terminal 400 are independent to each other and are located at different positions of the outer surface of the fixed unit 100, as shown in FIG. 1 to FIG. 10, in the present embodiment, and with reference of FIG. 2 and FIG. 3, waterfall water comes out of the first outlet terminal 300, and the second outlet terminal 400 is a handheld shower; the first outlet terminal 300 comprises a first outlet cavity 310 arranged in the fixed unit 100, namely the waterfall water passing cavity, and a first outlet cover body, namely the waterfall water cover body 320, wherein, a plurality of turbulent blocks 321 are arranged in the waterfall water cover body 320 for making the water pressure in the cover body even; for avoiding from contracting and crossing of the water that comes out of the waterfall water cover body, the cover body 320 is designed to be involute structure, and the outlet 322 expand outward with two big sides and small middle; apart from the space occupied by the turbulent blocks in the waterfall water cover body 320, the water passing areas are equal to each other along the outlet direction, so water comes out more even.

As shown in FIGS. 2, 4 and 5, the locating unit 500 is between the handle 210 and the water division disc 120, and contained in the locating slot 211, which comprises a locating pin 510 and a locating spring 520 that is against and adaptive to the locating pin 510, the locating pin 510 rotates along with the rotary assembly when the rotary assembly rotates with respect to the fixed unit 100, and because of the three locating holes 124, 125 and 126 arranged on the end face of the water division disc 120, the locating pin 510 can be alternatively located at one of the three locating holes 124, 125 and 126 with the cooperation of the locating spring 520 to locate the handle 210 in a rotating manner.

The outlet mechanism also comprises a socket 600, as shown in FIGS. 1 and 2, which is fixed to the fixed unit 100 through fixed block (such as screw) for clamping the outlet terminal (such as shower) or placing stuff

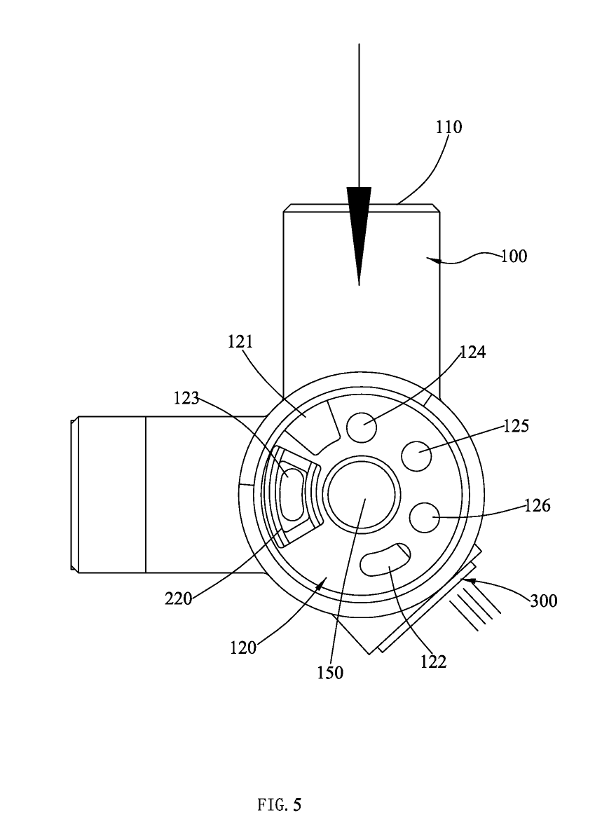

According to FIG. 5 to FIG. 10, the operating principle of the present outlet mechanism is described below:

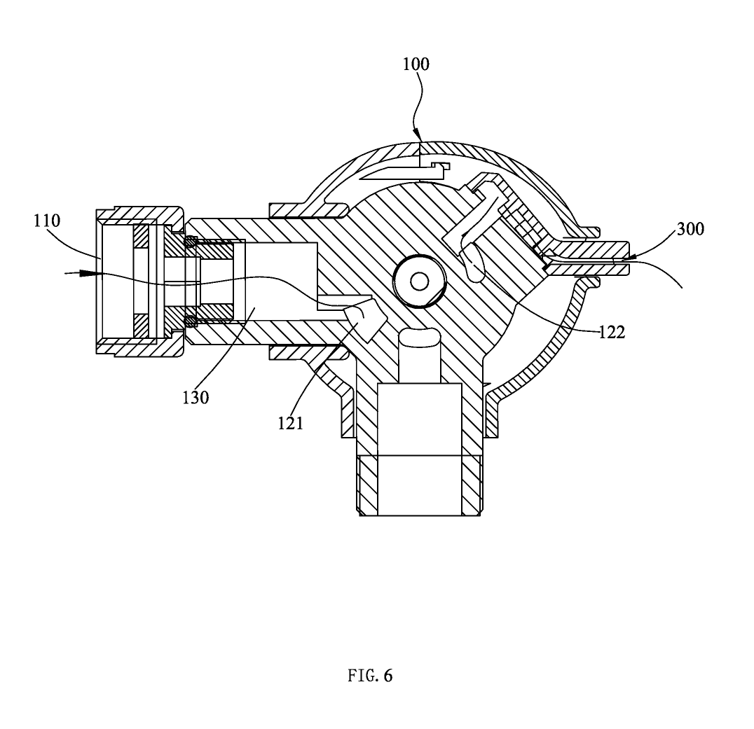

FIGS. 5 and 6 shows the abridged general view of the present outlet mechanism when water comes out of the first outlet terminal, assuming it is the initial state, the locating pin 510 is against the first locating hole 124 to locate the handle 210, and the second water division hole 123 is just block by the sealing gasket 220, but the first water division hole 122 is communicated with the inlet cavity 130, when the water resource is opened, water flow enters the inlet cavity 130 from the inlet end 110, then enters the waterfall water cover body 320 from the first water division hole 122, and then comes out of the first outlet terminal 300 after the water pressure is made even by the turbulent blocks 321, and the outlet effect is waterfall water;

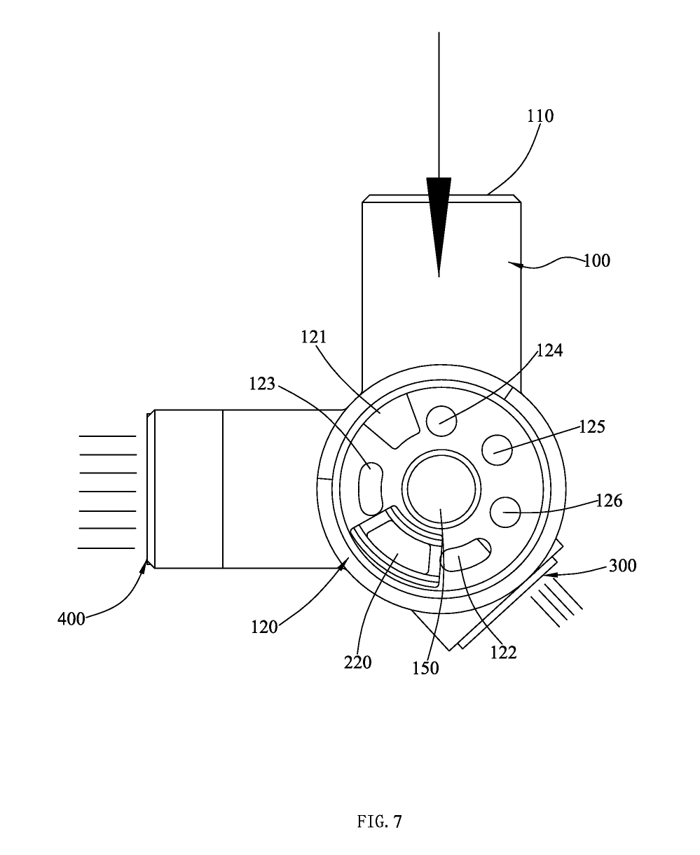

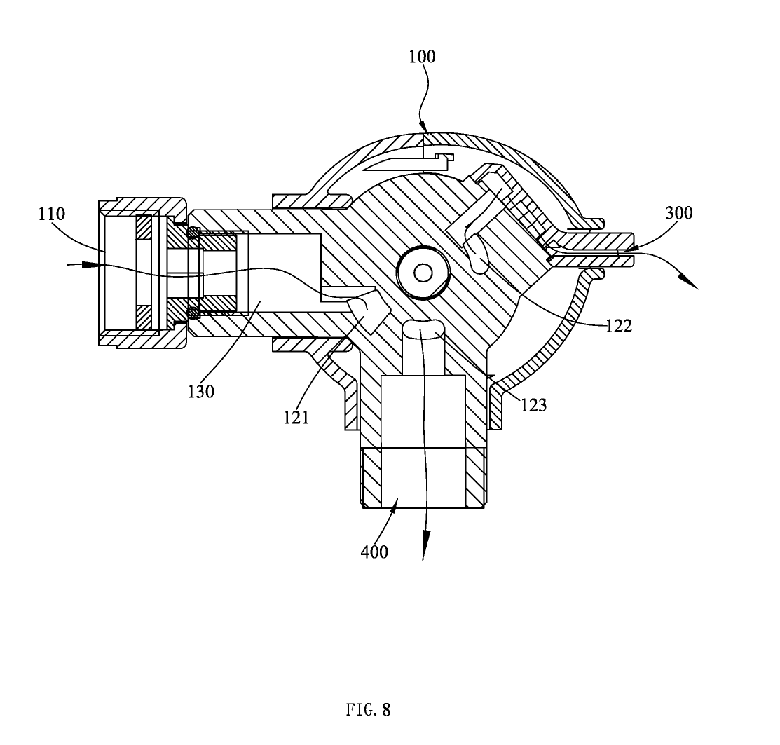

When water is needed to come out of the first and the second outlet terminals, as shown in FIGS. 7 and 8, the handle 210 is rotated, the locating pin 510 leaves the first locating hole 124 and turns to be against the second locating hole 125, then the handle 210 is stopped and located, the sealing gasket 220 rotates along with the rotation of the handle 210 and then located in the gap between the first water division hole 122 and the second water division hole 123 along with the location of the handle 210, and at this moment, the first water division hole 122 and the second water division hole 123 are both communicated with the inlet cavity 130, therefore water comes out of the first outlet terminal 300 and the second outlet terminal 400, the outlet effect is mixed water.

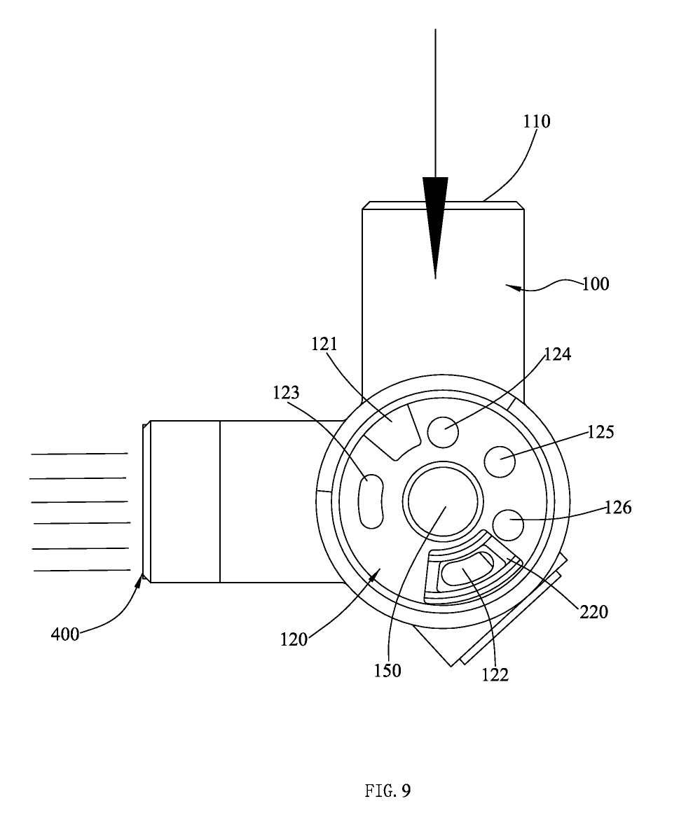

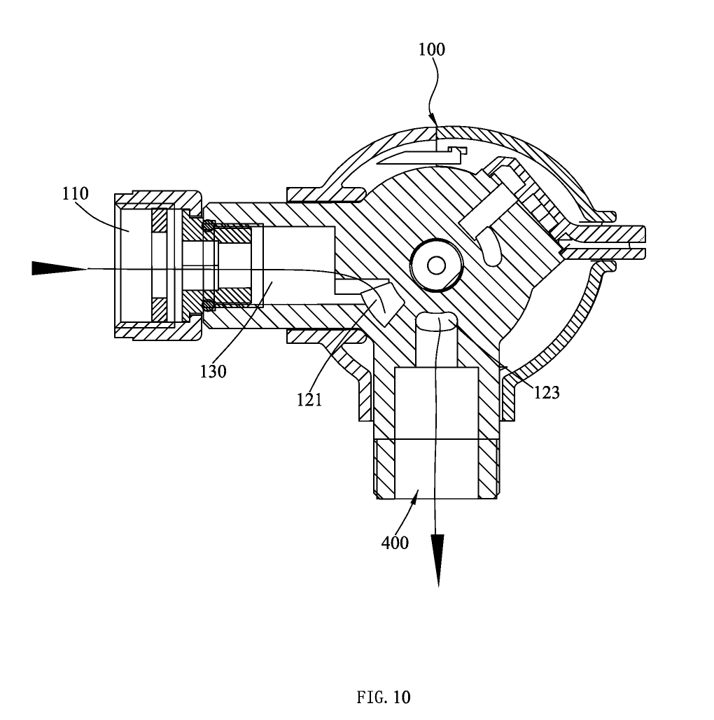

According to FIGS. 9 and 10, the handle 210 continuous to be rotated, so that the locating pin 510 overcomes the elastic force of the locating spring 520 and turns to be against the third locating hole 126, at this moment, the sealing gasket 220 rotates along with the rotation of the handle 210, and the first water division hole 122 is blocked by the sealing gasket 220 along with the locating of the handle 210, and the second water division hole 123 is communicated with the inlet cavity 130, therefore water only comes out of the second outlet terminal 400, namely the handheld shower.

The invention has been described with reference to the preferred embodiments mentioned above; therefore it cannot limit the reference implementation of the invention. It is obvious to a person skilled in the art that structural modification and changes can be carried out without leaving the scope of the claims hereinafter and the description above.

### INDUSTRIAL APPLICABILITY

The multi-function outlet mechanism in the present invention skillfully integrates multiple outlet terminals into one body, the structure is compact, and the function is various, and the applicability is strong, so the present invention is provided with good industrial applicability.

What is claimed is:

1. Multi-function outlet mechanism, comprises a fixed unit, a rotary assembly and two outlet terminals, wherein,
the fixed unit is provided with an inlet end;
the rotary assembly comprises a handle and a control part, the handle is mounted to the fixed unit in a rotating manner, and the control part is arranged in the fixed unit;
the outlet terminals are arranged on the fixed unit respectively, and water comes out of the outlet terminals simultaneously or separately along with the relative rotation between the rotary assembly and the fixed unit, the outlet effect of one of the outlet terminals is waterfall water.

2. Multi-function outlet mechanism according to claim 1, wherein, the fixed unit also comprises a water division disc, and an inlet cavity communicating with the inlet end is formed by the water division disc and the fixed unit.

3. Multi-function outlet mechanism according to claim 2, wherein, the inlet cavity is provided with an inlet hole, two water division holes communicating the inlet hole with the outlet terminals respectively are opened on the water division disc.

4. Multi-function outlet mechanism according to claim 3, wherein, the control part is a sealing gasket which is adaptive to the two water division holes and linked with the handle.

5. Multi-function outlet mechanism according to claim 2, wherein, also comprises a locating unit which comprises a locating pin and a locating spring that is against the locating pin, and three locating holes adaptive to the locating pin are arranged on the water division disc.

6. Multi-function outlet mechanism according to claim 5, wherein, a locating slot adaptive to the locating unit is arranged on the end face of the handle.

7. Multi-function outlet mechanism according to claim 1, wherein, the two outlet terminals are respectively arranged at different position of the outer surface of the fixed unit.

8. Multi-function outlet mechanism according to claim 1, wherein, a limit gap is arranged at the fixed unit, a limit boss adaptive to the limit gap is arranged at the corresponding position of the handle.

9. Multi-function outlet mechanism according to claim 1, wherein, a waterfall water outlet cavity is opened in the fixed unit, a waterfall water cover body covers the waterfall water outlet cavity, and a plurality of turbulent blocks are arranged in the waterfall water cover body, and the waterfall water cover body is involute structure, and its outlet expands outward with two big sides and small middle, and the water passing areas are equal to each other along the outlet direction.

10. Multi-function outlet mechanism according to claim 1, wherein, also comprises a socket fixedly connected to the fixed unit.

11. Multi-function outlet mechanism according to claim 4, wherein, the sealing gasket is sector structure, and is mounted at the lower end of the handle, and rotates along with the handle to block or communicate with the water division hole.

12. Multi-function outlet mechanism according to claim 11, wherein, the water division hole is cashew-shaped, the arc length of the sector structure of the sealing gasket is longer than the long apertures of the first water division hole and the second water division hole, and the width of the sector structure of the sealing gasket is not less than the short apertures of the first water division hole and the second water division hole.

13. Multi-function outlet mechanism according to claim 11, wherein, a splicing part is arranged at the lower end of the handle, and the sealing gasket is mounted at the splicing part at the lower end of the handle.
